(19) United States
(12) Patent Application Publication
(10) Pub. No.: US 2008/0102863 A1
(43) Pub. Date: May 1, 2008

(54) SYSTEM, METHOD, AND USER INTERFACE FOR SEARCHING FOR MESSAGES ASSOCIATED WITH A MESSAGE SERVICE ON A MOBILE DEVICE

(75) Inventors: Michael Thomas Hardy, Waterloo (CA); Andrew Douglas Bocking, Waterloo (CA)

Correspondence Address: BERESKIN AND PARR, 40 KING STREET WEST, BOX 401, TORONTO, ON, M5H 3Y2, US

(73) Assignee: RESEARCH IN MOTION LIMITED, Waterloo, ON (CA)

(21) Appl. No.: 11/554,989

(22) Filed: Oct. 31, 2006

(51) Int. Cl. H04Q 7/20

(52) U.S. Cl. 455/466

(57) ABSTRACT

Embodiments of a system, method, and user interface for searching for messages associated with a message service on mobile devices are disclosed. In one embodiment, a messaging application is programmed such that, in operation, a user is presented with a search screen in which the user may define search parameters for a search. A search parameter associated with an option to search for messages associated with one or more message services (e.g. user message accounts) as identified by the user is provided.

### RELEVANT FIELD

Embodiments described herein relate generally to messaging applications for use with mobile devices, and more particularly to a system, method, and user interface for searching for messages (e.g. electronic mail messages) on a mobile device.

### BACKGROUND

Electronic systems that “push” (i.e. automatically transmit) electronic mail (“e-mail”) messages to wireless communication devices are well-known. In an exemplary system, an intermediary server monitors an “inbox” (typically, a folder or other store where incoming messages are stored) of an e-mail account at an e-mail server. When an e-mail message arrives at the monitored inbox, the intermediary server “pushes” the e-mail message to the wireless communication device (also referred to herein as a “mobile device”) by way of a data network (such as the public Internet) and a wireless network.

A user may set up one or more accounts with multiple e-mail service providers. For example, a user may have set up one or more corporate e-mail accounts, as well as one or more personal accounts. At least some of these accounts may be provisioned on the user's mobile device, such that e-mail messages that arrive for the user and that are associated with those provisioned accounts can be pushed to the user's mobile device. In some instances, messages associated with multiple accounts may be consolidated in some manner before being pushed to the mobile device.

When messages arrive at the mobile device, these messages may be identified in a message list. However, the user may find it difficult to differentiate between messages associated with different message services that are identified in the message list. More specifically, the user may find it difficult to identify messages that originated from or are otherwise associated with a particular message service (e.g. account).

### BRIEF DESCRIPTION OF THE DRAWINGS

For a better understanding of embodiments of the systems, methods, and user interfaces described herein, and to show more clearly how they may be carried into effect, reference will be made, by way of example, to the accompanying drawings in which:

FIG. 1 is a schematic diagram illustrating a system that supports searching by message service at a mobile device in one exemplary embodiment;

FIG. 2 illustrates a mobile device component of FIG. 1 in one exemplary embodiment;

FIG. 3 illustrates an instance of an object-oriented class that is instantiated in the memory of the mobile device of FIG. 2 to represent an e-mail message in one exemplary embodiment;

FIGS. 4 and 5 illustrate examples of screenshots of a graphical user interface provided on the mobile device of FIG. 2;

FIGS. 6A to 6H illustrate further examples of screenshots of a graphical user interface provided on the mobile device of FIG. 2; and

FIG. 7 is a flowchart illustrating steps of a method of searching for messages associated with a message service on the mobile device of FIG. 2 in at least one embodiment.

### DETAILED DESCRIPTION

Many known messaging applications are programmed to allow users to search for e-mail messages that contain specified text in various e-mail message fields (e.g. message body, subject field, addressee fields).

At least some embodiments of the systems, methods, and user interfaces described herein relate generally to mobile device messaging applications, and more specifically to messaging applications that provide users with improved search capabilities.

For example, in exemplary embodiments described herein, a search for messages associated with one or more message services may be initiated by a user, through a user interface provided by a messaging application executing on a mobile device.

The terms “mobile device” and “wireless communication device” may be used interchangeably herein.

In one broad aspect, there is provided a method of searching for messages associated with a message service on a mobile device, the method comprising the steps of: displaying a plurality of search parameters in a search screen to a user, wherein one of said plurality of search parameters is associated with an option to search for messages associated with a specified message service on the mobile device; receiving a request from the user to modify the value of the search parameter associated with the option to search for messages associated with a specified message service; displaying one or more user-selectable message services in response to the request; receiving input identifying a message service selected by the user from the displayed user-selectable message services; executing a message search; and displaying results of the message search in a search results screen, wherein messages associated with the message service selected by the user are identified by the message search.

In one embodiment, only message services that are provisioned on the mobile device are displayed at the step of displaying one or more user-selectable message services.

Features of these and other aspects, and of a number of embodiments of systems, methods, and user interfaces are described below.

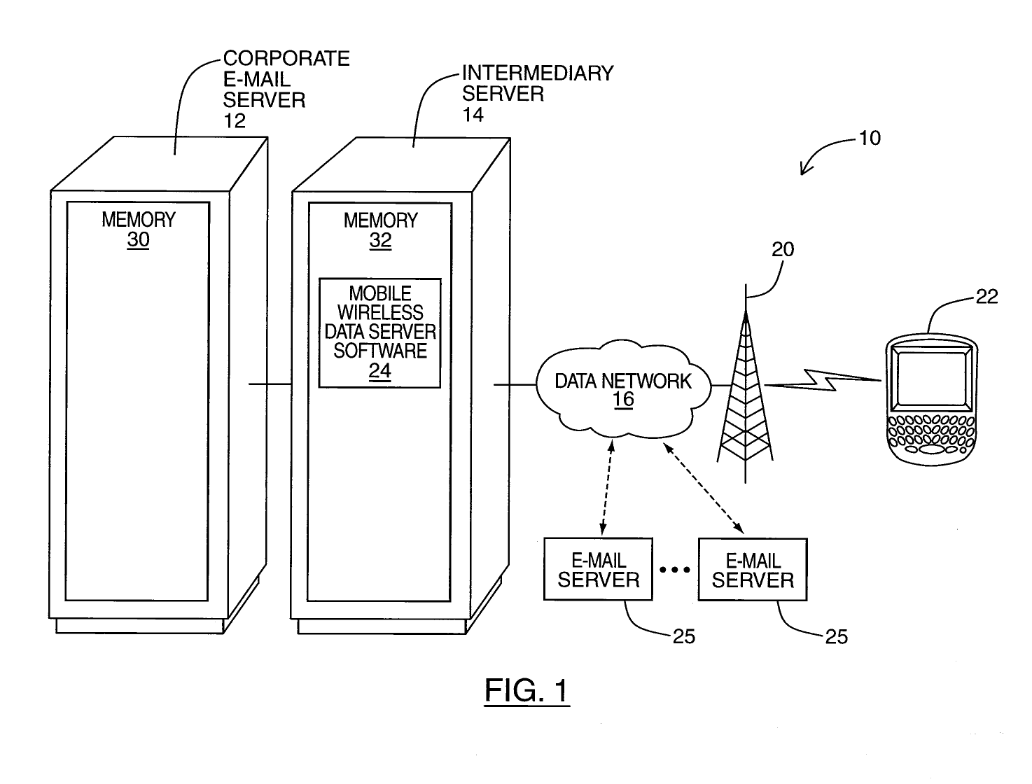

FIG. 1 illustrates an exemplary system 10 that supports searching by message service at a mobile device. The system 10 is a modification of a conventional system that automatically transmits (“pushes”) e-mail messages to mobile devices. As illustrated, system 10 includes an e-mail server 12, an intermediary server 14, a data network 16, a wireless network 20 and a mobile device 22.

E-mail server 12 is a conventional server executing messaging and collaboration software such as Microsoft® Exchange Server, Lotus® Domino® Server or the like. E-mail server 12 may be designed to maintain multiple e-mail accounts, each of which has an inbox for incoming e-mail messages. E-mail server 12 includes memory 30 in addition to other conventional components such as a processor (the other components being omitted from FIG. 1 for brevity).

In this example, intermediary server 14 comprises mobile wireless data server software 24. The mobile wireless data server software 24 is a software application that is responsible for “pushing” e-mail messages received at the inboxes of specified e-mail accounts of e-mail server 12 to the mobile device 22, in a conventional manner. The software 24 communicates with e-mail server 12 for purposes of monitoring the specified e-mail account inboxes.

In this example, when a new e-mail message is detected, the e-mail message is automatically converted to a format known as Compressed Multipurpose Internet Mail Extensions (CMIME), and transmitted to the mobile device 22 as a stream of bytes, via data network 16 (possibly through a firewall, not expressly illustrated in FIG. 1). In addition, the software 24 may receive e-mail attachment requests from device 22 and may intercommunicate with an attachment server (not shown) for the purpose of obtaining the desired attachment (or a portion thereof, as discussed below) for transmission to the device 22, on an on-demand basis.

Data network 16 is a conventional data network, which is used to transmit e-mail messages to mobile device 22. The network may deliver e-mail messages to a network operation centre (not illustrated), for purposes of relaying to the wireless network 20.

Data network 16 may be the public Internet or a privately managed and operated Internet Protocol (IP) network for example.

Wireless network 20 is a conventional wireless network, which serves as the final link in the communication chain between the intermediary server 14 and the mobile device 22. Network 20 may for example be a mobile data communication network, such as a Mobitex™, DataTAC™ or General Packet Radio Service (GPRS) mobile data communication network, or a conventional voice communication network, such as Advanced Mobile Phone Service (AMPS), Time Division Multiple Access (TDMA), Code Division Multiple Access CDMA, Personal Communications Service (PCS) or Global System for Mobile Communications (GSM), for example. Other types of data and voice networks, separate and integrated, could alternatively be utilized for network 20.

In this example, e-mail server 12 is a corporate e-mail server providing a user of device 22 with an e-mail service. Before a user may receive e-mail from e-mail server 12 (e.g. via intermediary server 14), the user must be set up to receive e-mails associated with his account, typically by first registering for an e-mail account with the organization (that also usually maintains the corporate e-mail server), and then provisioning the e-mail service at the device 22.

Similarly, as shown in FIG. 1, one or more other e-mail servers 25 may be set up to provide e-mail services to the user of device 22 via data network 16 and wireless network 20, for example. Before a user may receive e-mail from one of the other e-mail servers 25, the user must typically first register for an e-mail account with the associated e-mail service provider, and then provision that particular account at the device 22. As with e-mail server 12, e-mail may also be pushed to device 22 from e-mail server 25 via an intermediary server [not expressly shown in FIG. 1], which may have similar functionality as intermediary server 14.

Accordingly, a user may have one or more e-mail accounts to which e-mail may be sent, and which subsequently may be pushed to device 22, or pulled from device 22 in some instances.

Although a user may be set up with multiple accounts from the same service provider, in the specification and in the claims, each “account” belonging to a user may also be more generally referred to as a “service”.

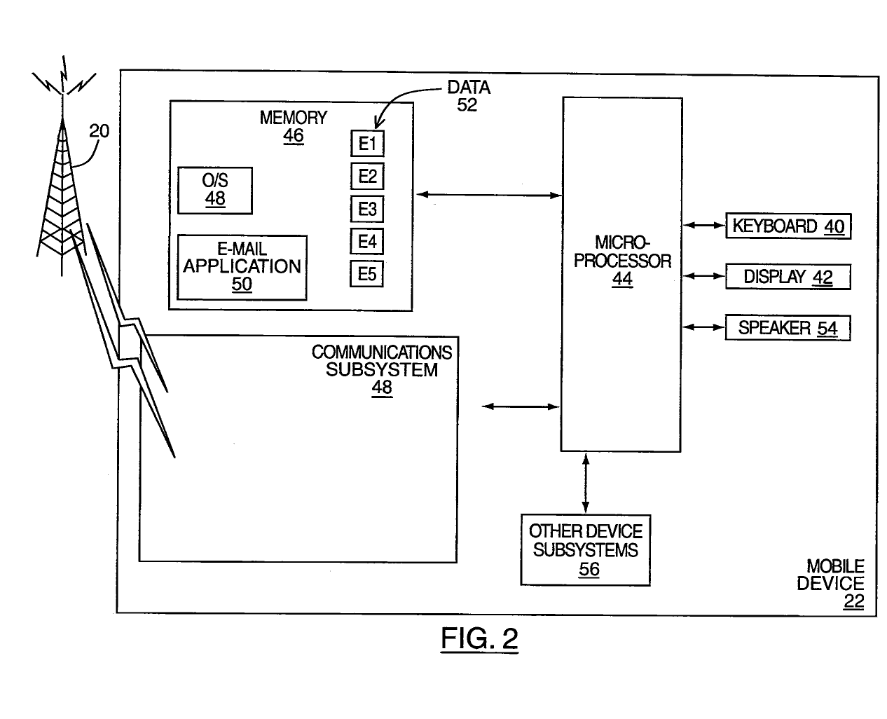

Mobile device 22 is a two-way radio frequency (RF) communication device having data communication capabilities, which has been modified from a conventional configuration in order to support searching by message service, as described below. Mobile device 22 is illustrated in greater detail in FIG. 2, in respect of one exemplary embodiment.

Referring to FIG. 2, mobile device 22 (also referred to as a mobile communication device) includes a keyboard 40, a display 42, a microprocessor 44, memory 46 and a communications subsystem 48. The mobile device 22 will typically comprise other components, which have been omitted from FIG. 2 for brevity. The components shown are communicatively coupled as illustrated in FIG. 2.

Keyboard 40 is a user input device which permits a user of the mobile device 22 to enter text for such purposes as composing and sending e-mail messages or specifying criteria for searching locally stored e-mail messages for example. Other user input devices may also be provided, including a track wheel or track ball (not expressly shown in FIG. 2), for example.

Display 42 is an output device that is capable of presenting a graphical user interface (GUI) to a user. The display 42 may be a full graphic Liquid Crystal Display (LCD), for example. The display 42 is used to display e-mail messages to the user, for example. The dimensions of display 42 may be limited due to the limited overall size of the device 22.

Microprocessor 44 is a conventional processor which controls the overall operation of the mobile device 22 based on user actuation of keys on the keyboard 40, user input received through other input devices, and the receipt of data from wireless network 20, for example. The microprocessor 44 executes operating system software and application software that is stored in local memory 46. Microprocessor 44 is communicatively coupled (either directly or indirectly) to the keyboard 40, display 42, memory 46 and communication subsystem 48, as illustrated in FIG. 2.

Memory 46 stores various software and data used at the device 22, including operating system software 48, e-mail application 50 and data 52. Memory 46 may consist of flash memory, random access memory (RAM), read only memory (ROM), or a combination of these, for example. Typically, at least some of memory 46 will be persistent. It will be appreciated that memory 46 is a form of machine-readable medium.

Operating system software 48 is software that governs the basic operation of mobile device 22.

E-mail application 50 is a software application that is capable of managing and displaying e-mail messages at device 22. The application 50 is modified from a conventional e-mail application to support searching by message service at device 22, as will be described. The application 50 may be one of many application software modules resident in memory 46 (not expressly illustrated). The application 50 includes machine-executable code. Where an e-mail application 50 is capable of managing other messages in addition to e-mails, it may also be referred to more generally as a messaging application.

Data 52 is data that is generated or used by e-mail application 50 at device 22. In the example shown, data 52 includes five e-mail message objects E1, E2, E3, E4 and E5. Each of the e-mail messages objects of FIG. 2 is an instance of a Java object-oriented class representing an e-mail message of like name that has been “pushed” to the device by the intermediary server 14. Each e-mail message object is instantiated at the device upon the receipt of a CMIME byte stream representing that message from the intermediary server 14.

Communication subsystem 48 is responsible for effecting data communications (and possibly voice communications) between the device 22 and the rest of system 10 via wireless network 20. Subsystem 48 may include such components as a receiver, a transmitter, one or more antennas, and a digital signal processor (none of which are expressly illustrated). The specific design and implementation of the communication subsystem 48 is dependent upon the communication network 20 in which the mobile device 22 is intended to operate.

The wireless communication device 22 also includes a speaker 54 and may further include various other device subsystems 56.

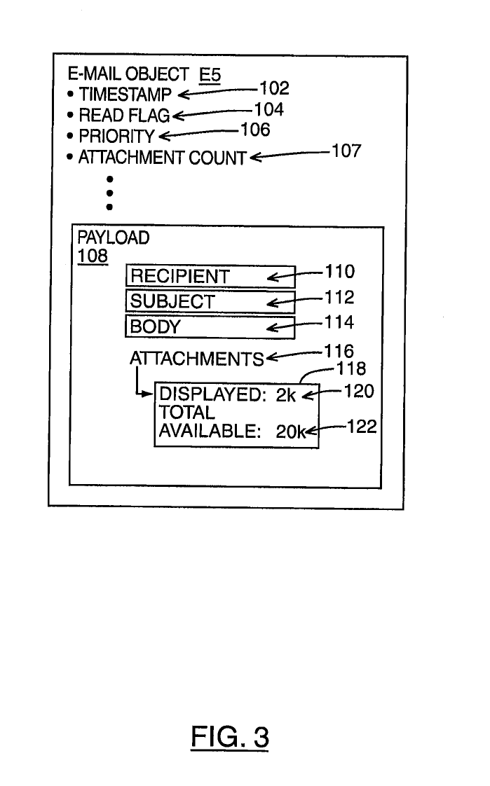

FIG. 3 illustrates exemplary e-mail object E5 of FIG. 2 in greater detail. As shown in FIG. 3, e-mail object E5 is an instance of an object-oriented Java class having various attributes, such as a timestamp (time of arrival) attribute 102, a read flag attribute 104 indicating whether or not the e-mail message has been read, a priority attribute 106 indicating e-mail message priority, and an attachment count 107 indicating the number of attachments of the represented e-mail message. Other attributes may be present but have been omitted from FIG. 3 for brevity.

The object E5 also contains a subordinate payload object 108. Payload object 108 is a container object containing various subordinate objects representing various other components of e-mail message E5. The subordinate objects include a message recipient object 110, a message subject object 112, a message body object 114 and potentially a set of attachment objects 116.

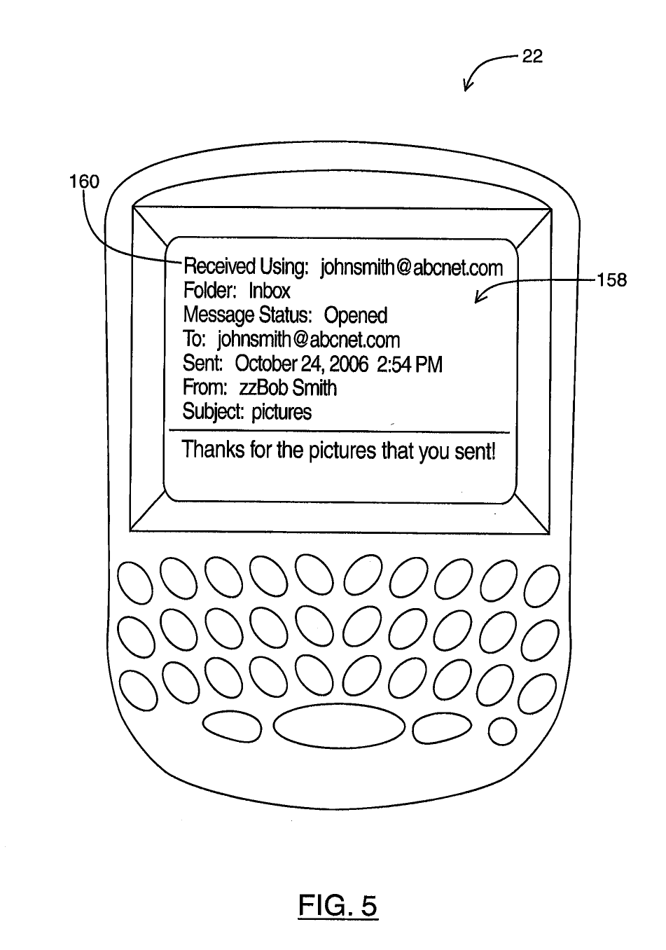

Although not explicitly shown in FIG. 3, the e-mail object E5 will typically also contain an object to store data that can be used to identify the e-mail service (e.g. account) from which the corresponding e-mail originates or with which the corresponding e-mail is otherwise associated. For example, data that may be used to identify a specific account can be in the form of an e-mail address, or some account name associated with that account (see e.g. 160 of FIG. 5). Accordingly, device 22 may be provisioned to expect and accept e-mails that were originally sent to that user at the e-mail address associated with the specific account.

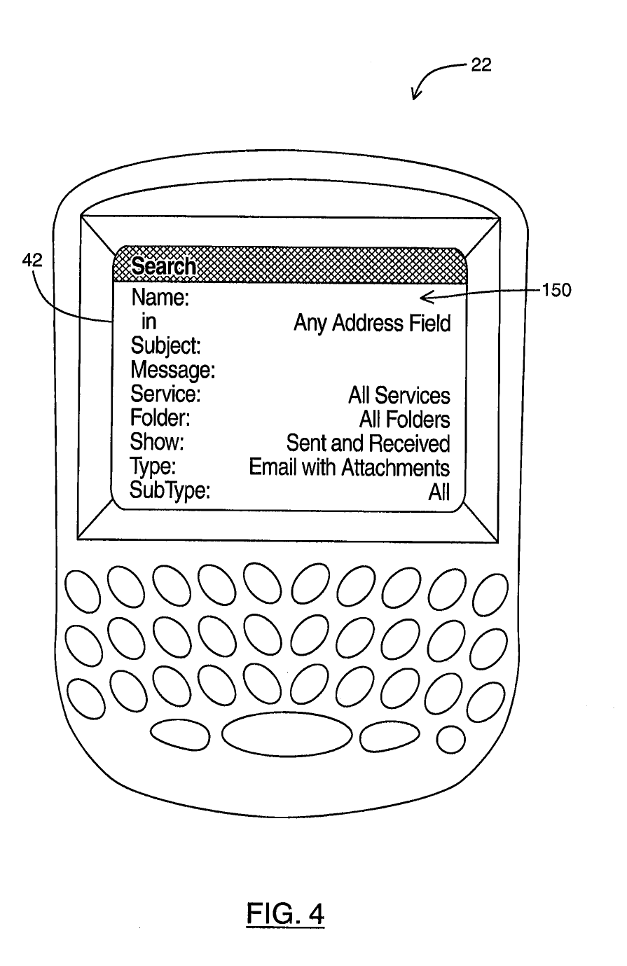

Referring to FIG. 4, a graphical user interface (GUI) screen 150 displayed on the display 42 of mobile device 22 is illustrated. The GUI screen 150 is presented by the e-mail application 50 (FIG. 2) upon the entry of user commands at device 22 indicating a desire to search e-mail messages (or other types of messages) stored at device 22 based on user-specified search parameters. The user may interact with GUI screen 150 to specify parameters for the search.

As illustrated in FIG. 4, search parameters that may be specified by a user of device 22 may include: text to be matched within a specified address field (such as the To:, From:, CC: or BCC: field of an e-mail message for example), subject line, or message body; a service (e.g. an e-mail account provider) through which the message was received in accordance with embodiments described herein; the identity of message containing folders within the specified service(s); whether incoming messages, outgoing messages, or both should be searched, and messages by type and/or subtype. These are provided by way of example only, and a messaging application may be configured to allow a user to specify different parameters, or only a subset of the above parameters, for example.

Referring to FIG. 5, an example of a message 158 being viewed by a user is shown. Header information is shown with the text and/or other content of the message 158. In addition to typical message details provided in the header, which may include for example, the folder in which the message being viewed is currently stored, the current status of the message being viewed, the addressee of the message being viewed, the date and time that the message is purported to have been sent, the sender of the message being viewed, and the subject of the message being viewed, there is also typically shown a “Received Using:” field for a received message or a “Sent Using:” field for a sent message. In this example, a “Received Using:” entry 160 is shown. This entry 160 indicates to the user that the message originated from the user's Desktop account.

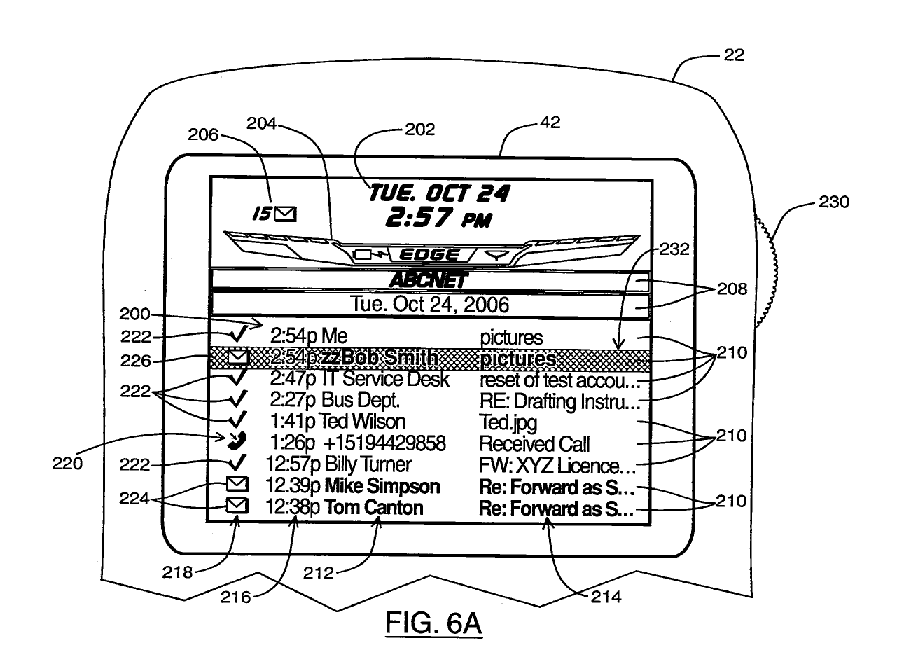

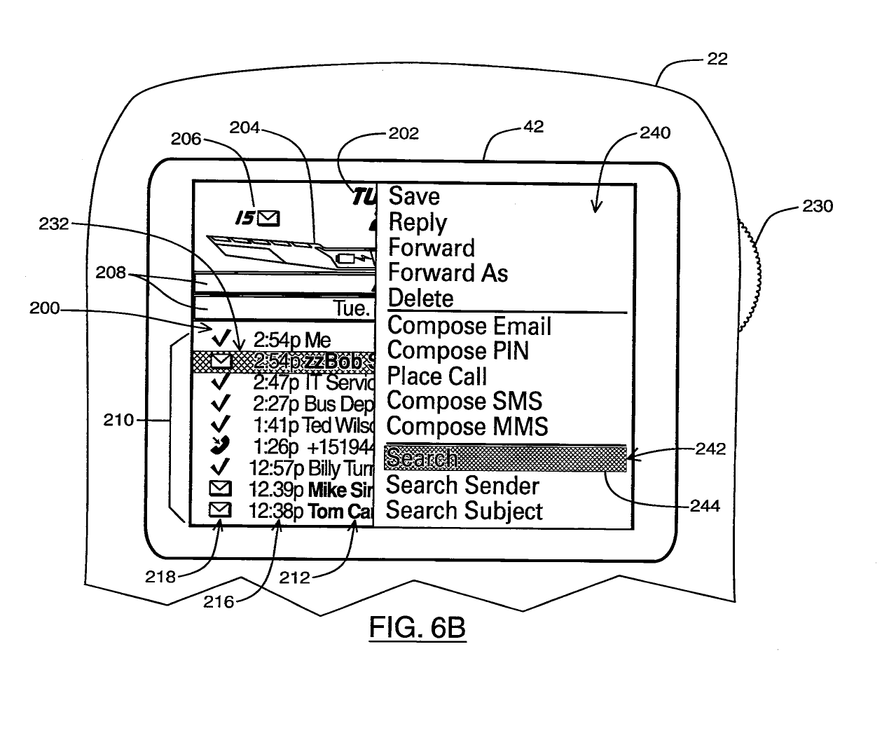

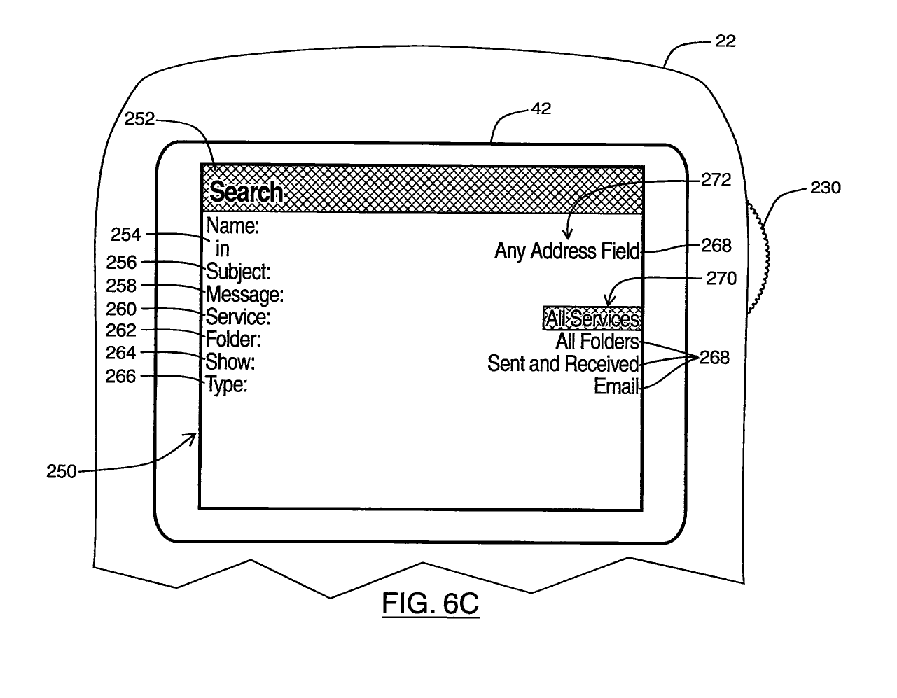

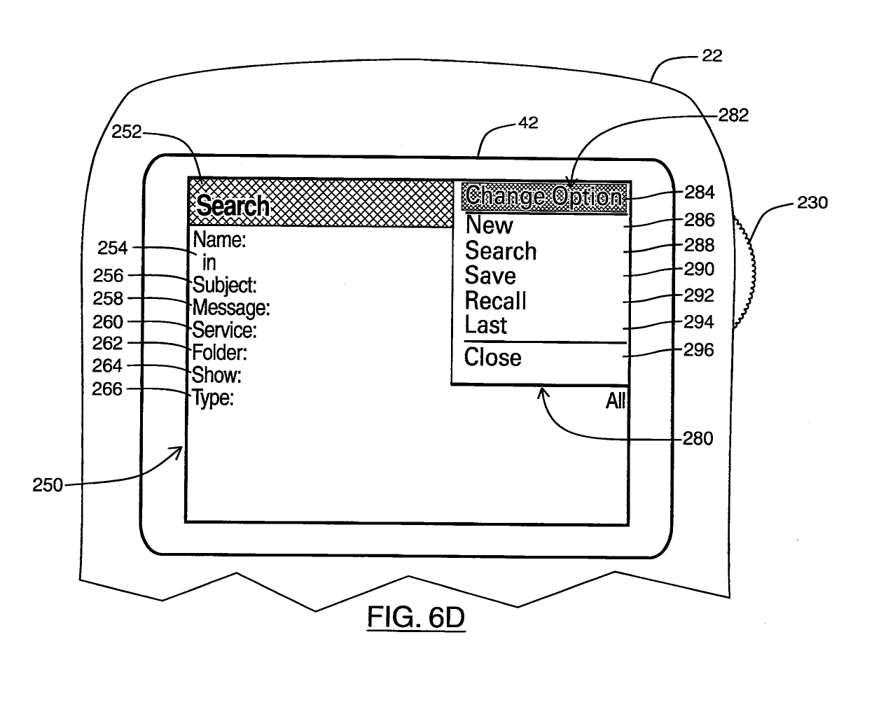

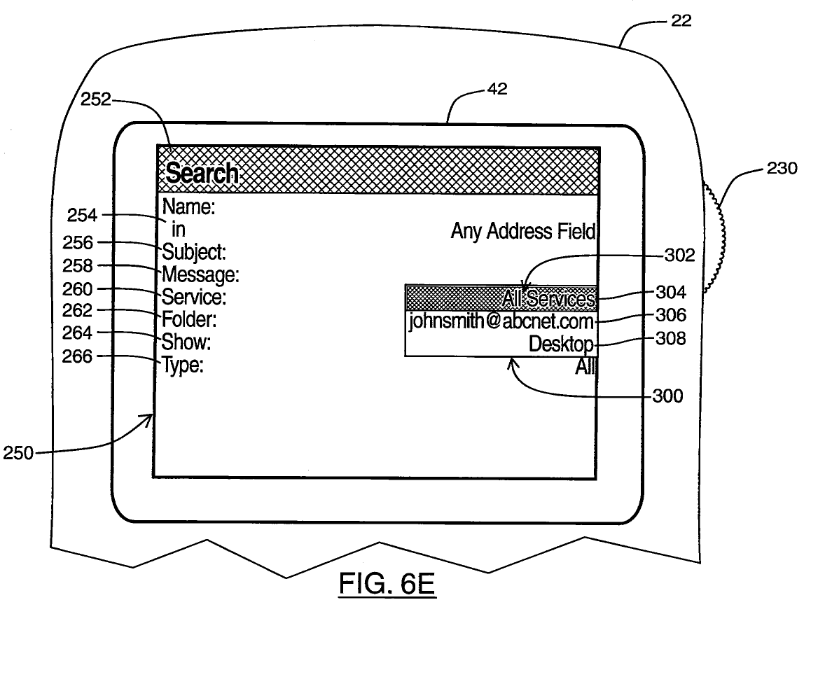

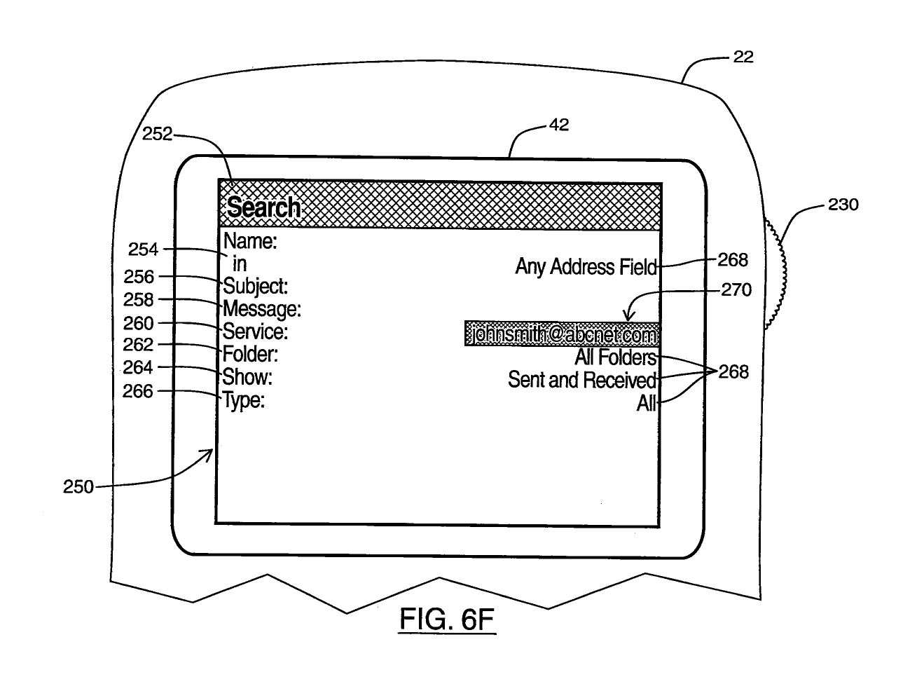

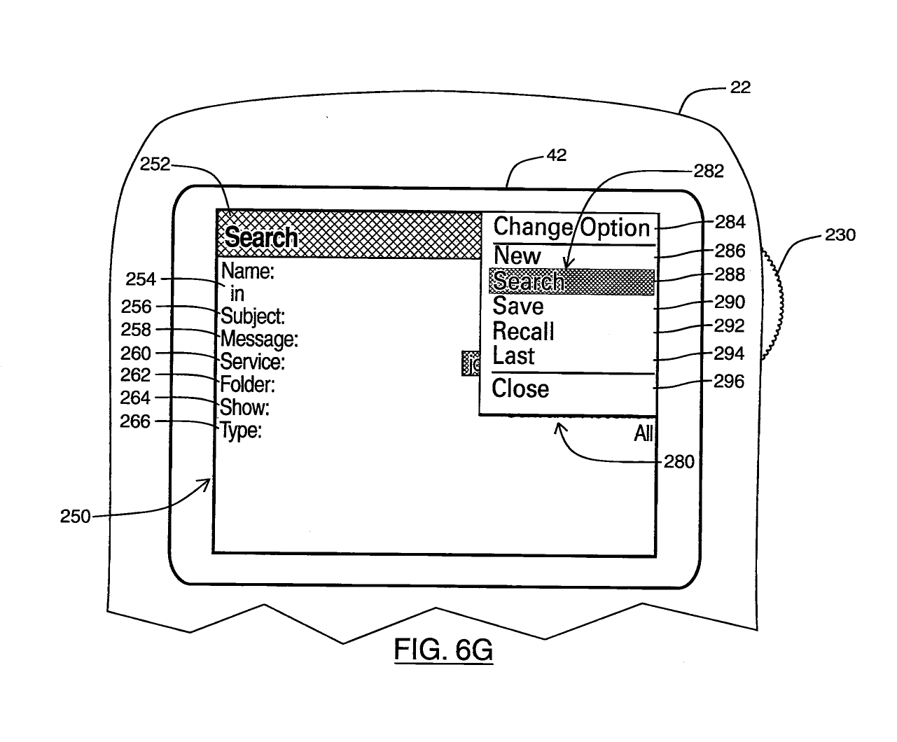

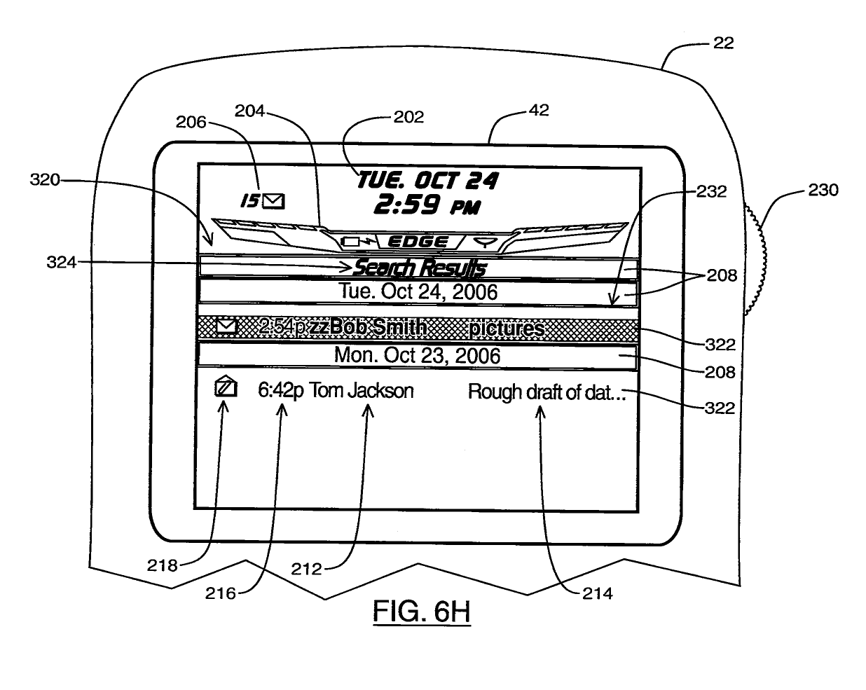

An example that more specifically illustrates a number of features of at least one embodiment described herein, is now provided with reference to FIGS. 6A to 6G, in which a user searches for all e-mail messages associated with a specific message service and for which details are shown in a message list. This may allow users to quickly differentiate between different e-mail messages that were sent to different user accounts within the message list, for example.

Consider the situation where a user receives multiple e-mail messages from different accounts, all of which may be read at the mobile device. If the user wishes to differentiate between messages that may be related to different purposes (e.g. work mail, personal mail, general mail), it may be difficult to do so if the number of messages for which details are shown in the message list is large. If the messaging application is programmed to allow users to reply to messages so that it would appear to the original sender that the reply is originating from a specific user's account for example, the user may wish to first identify and verify the specific account that the original message was sent to.

Accordingly, allowing users to search for messages associated with one or more specified message services, and to have them identified in a list of messages returned as a result of a search, may facilitate easier identification of the message service (e.g. account) with which a message received at the mobile device is associated.

Referring to FIGS. 6A to 6H, further examples of screenshots of a graphical user interface provided by an application executing on the mobile device of FIG. 2, in one exemplary embodiment are shown. In this embodiment, the application executing on the mobile device is a messaging application.

In FIG. 6A, a message list 200 displayed by the messaging application in a display 42 of device 22, in a message list view, is shown.

In this view, details such as, for example: the current time and date 202; battery strength, signal strength, or other network details 204; an indicator 206 of the number of messages in message list 200 that have not yet been read; and one or more banners 208 that may be used to display date, network, user identification, device identification data or other data.

In this example, message list 200 comprises multiple list entries 210, where each message that has been received by the user at the device 22 and stored in one or more of the user's inbox folders (potentially associated with different e-mail services or accounts) is associated with one of the list entries 210. Each list entry 210 in the message list 200 provides details of the message associated with the respective list entry 210. Other list entries 210 in the message list 200 may exist, but which are not displayed in display 42 due to space restrictions. Accordingly, the messaging application will typically allow users to scroll up and down through message list 200 to examine all list entries 210 in message list 200.

The details that are to be provided by the list entries 210 of message list 200 may be configurable by the user. Message list 200 permits users to, for example, browse through a summary of messages received at device 22, and select messages of interest for opening so that the contents of the message may be read or otherwise managed at the device 22.

With respect to messages received at the device, the details provided by a list entry 210 may be extracted from the message header of the message associated with the list entry 210, such as the name of the sender or recipient of a sent message that may be displayed in a detail column 212 and the subject of the message that may be displayed in a detail column 214, for example. Other details may also be provided, including for example, the time the message was received at the device that may be displayed in a detail column 216, or an icon indicating whether or not the message has been opened (“read”) by the user or whether or not the sending of a message has been completed in a detail column 218.

Other details relating to other data (e.g. telephone calls that are placed and received from the device) may also be integrated into the message list, with data provided in detail columns 212 to 218. For example, list entry 220 as shown in FIG. 6A provides detail of a call received at the device 22.

In one embodiment, different icons are used to indicate whether a received message has been read, and whether a message has been sent.

For example, a check mark 222 can be used to indicate that the message associated with the corresponding list entry 210 has been sent.

An unopened envelope icon 224 can be used to indicate that the message associated with the corresponding list entry 210 has not yet been read. This list entry 210 may also be highlighted (e.g. to indicate a high priority message).

Similarly, an opened envelope icon (not shown in FIG. 6A) can be used to indicate that the message associated with the corresponding list entry 210 has been read.

A list entry 210 may be selected by the user, as shown at 226. The user may use a track wheel 230 on device 22, where provided, to manipulate a highlight bar 232 in display 42 to make the selection. The highlight bar 232 may be manipulated using a different input mechanism (e.g. track ball, keyboard) in some implementations.

By rotating track wheel 230, highlight bar 232 may be re-positioned to highlight different list entries 210 of message list 200. Once the user identifies a specific list entry, by manipulating the track wheel 230 so that the highlight bar 232 settles on that specific list entry, the user may then take further action in respect of the message associated with that list entry or take some other general action. For example, the user may click the track wheel 230 to reveal an option menu 240, as shown in FIG. 6B.

Referring to FIG. 6B, when option menu 240 is shown, by rotating track wheel 230, a second highlight bar 242 may be re-positioned to highlight different options within option menu 240. In this example, option menu 240 provides different options that allow users to perform certain operations on the selected message, and/or to perform operations not specific to the selected message.

For example, options that may be selected by the user from option menu 240 may allow the user to: obtain help, open the selected message, file the selected message in a specific folder, mark the selected message as unopened, save the selected message in a saved message folder, reply to the selected message, forward the selected message, delete the selected message, compose a new e-mail message, compose a new PIN message, place a call, compose a Short Message Service (SMS) message, compose a Multimedia Message Service (MMS) message, perform a general search for messages (as described herein), perform a specific search for messages from a particular sender, perform a specific search for messages with a particular subject, view the contents of a particular message folder, view the contents of the saved messages folder, configure device options, reconcile messages with those saved on a server, and close the option menu 240. It will be understood that these options are described herein by way of example, and different combinations and subsets of these and other options may be available in variant embodiments.

In this example, the user has identified a message search option 244, manipulating the track wheel 230 so that the highlight bar 242 settles on that option. The user may then initiate the search by, for example, clicking the track wheel 230 to reveal a search screen 250, as shown in FIG. 6C.

Referring to FIG. 6C, search screen 250 is similar to GUI screen 150 of FIG. 4, except that in the example of FIG. 6C, the subtype parameter option (154 of FIG. 4) is not available to the user.

The display of search screen 250 may include a header 252 with the title “SEARCH” or the like, indicating to the user that he may interact with search screen 250 to specify parameters for a search.

Search options that are made available to a user of device 22 may include, for example: search options 254, 256, 258 where text is to be matched within a specified address field (e.g. the To:, From:, CC: or BCC: field of an e-mail message), subject line, and/or message body respectively when identifying messages; search option 260 where messages received via a particular service (e.g. an e-mail account provider) are to be identified, as described herein with reference to exemplary embodiments; search option 262 where messages in specified folders are to be searched; search option 264 to indicate whether incoming messages, outgoing messages, or both should be searched; and/or search option 266 that is used when messages of a particular type are to be identified. The messaging application may be configured to display default values 268 for all, some, or none of these options, as shown in the example of FIG. 6C.

With respect to the function provided allowing users to search by a particular message service, in use, the user may modify the value of the search parameters associated with search option 260. By rotating track wheel 230, highlight bar 270 may be re-positioned to highlight different data entry fields 272 for the values of search parameters corresponding to search options (254 to 266) shown in search screen 250. Once the user identifies a specific entry field associated with a corresponding search option, by manipulating the track wheel 230 so that the highlight bar 270 settles on that specific entry field, the user may then take further action in respect of the corresponding search option. For example, the user may click the track wheel 230 when the highlight bar 270 has settled on the entry field associated with search option 260 (i.e. search for messages by message service), to reveal an option menu 280 as shown in FIG. 6D.

Referring to FIG. 6D, when option menu 280 is shown, by rotating track wheel 230, a highlight bar 282 may be re-positioned to highlight different options within option menu 280. In this example, option menu 280 provides different options that allow users to perform certain operations on the selected search option, or to perform operations not specific to the selected search option. Different options or groups thereof within option menu 280 may be separated by one or more line separators.

For example, options that may be selected by the user from option menu 280 may include: an option 284 to change the value of the parameter as highlighted by highlight bar 270 (FIG. 6C), an option 286 to initiate a new search, an option 288 to execute a search with the currently-set search parameter values, an option 290 to save the currently-set search parameter values as a search in a memory for later recall, an option 292 to recall the search parameter values for a saved search, an option 294 to recall the search parameter values associated with the last search performed by the user, and an option to close the option menu 280. It will be understood that these options are described herein by way of example, and different combinations and subsets of these and other options may be available in variant embodiments.

In this example, the user clicks the track wheel 230 when the highlight bar 282 has settled on option 284 to change the value of the parameter as highlighted by highlight bar 270 (FIG. 6C), to reveal a further option menu 280 with message services (e.g. accounts), as shown in FIG. 6E.

Referring to FIG. 6E, when option menu 300 is shown, by rotating track wheel 230, a highlight bar 302 may be re-positioned to highlight different options within option menu 300. In this example, option menu 300 allows users to select a message service or account. An account may be identified by a common name, as may be configured (e.g. by an administrator) at the time of provisioning, for example. Alternatively, an account may also be identified by an e-mail address, representing the e-mail address of the user to which e-mails intended for the user may be sent. It will be understood that other account identifiers or labels may be used in variant embodiments.

In one embodiment, only active e-mail services that have been provisioned on the mobile device will be shown in option menu 300. Services that are not active or have not been provisioned on the mobile device will not be listed even if there are messages on the device that are associated with such a service, in this embodiment.

In at least one embodiment, an “all services” entry 304 will be provided in option menu 300. In one embodiment, the “all services” entry 304 will be provided as the first item in option menu 300.

In this example, the “all services” entry 304 may be selected to request that all messages on the device be returned by the search, regardless of the service associated with them, and whether or not the message is associated with a service that is not active or has not been provisioned on the mobile device.

In a variant embodiment, messages associated with a service that is not active or has not been provisioned on the mobile device may not be returned in a search even if the “all services” entry 304 is selected.

When an entry 306, 308 in option menu 300 other than the “all services” entry 304 is selected, this will constitute a request to search for and identify messages associated with the particular message service (e.g. account) identified by the selection. For example, entry 306 may identify a user's personal account, while entry 308 may identify a user's account with an organization (e.g. where e-mails are provided by a corporate e-mail server).

In this example, the user operates the track wheel 230 to re-position the highlight bar 302 shown in FIG. 6E as highlighting the “all services” entry 304, to a different entry 306. After clicking the track wheel 230, the selection is reflected on search screen 250, as shown in FIG. 6F. The user then clicks the track wheel 230 to reveal an option menu 280, as shown in FIG. 6G.

Referring to FIG. 6G, the user has rotated the track wheel 230 to re-position highlight bar 282. The option 288 to execute a search with the currently-set search parameter values in option menu 280 is highlighted. In this example, the user clicks the track wheel 230 to initiate the search for e-mails associated with the message service identified by entry 306 of FIG. 6E, from the messages for which details are displayed in the message list 200 of FIG. 6A.

Referring to FIG. 6H, a search result screen 320 displayed by the messaging application in the display 42 of device 22 is shown. In this example, search result screen 320 displays the result of the search for e-mails by message service, as initiated by the user through the actions described with reference to FIGS. 6A to 6G. Each message that has been located in the search that satisfies the search criteria input by the user is associated with a search result entry 322, as selected from messages associated with the list entries 210 of message list 200.

Although not directly apparent from visual inspection of the search result entries 322 shown in FIG. 6H, each of the messages associated with the search result entries was originally sent to the user via the service (e.g. account) associated with the message service identified by the selected entry 306 of FIG. 6E, and accordingly appears in search result screen 320.

In one embodiment, a header 324 or other indication that search results are being returned is displayed in a banner 208. Other banners 208 may be used to display other information, such as the date that the messages that are returned by the search and are grouped under the respective banner were sent or received, for example.

The features described with reference to FIGS. 6A and 6H, are described in combination by way of example only. The features may be provided independently and/or in other combinations in variant implementations.

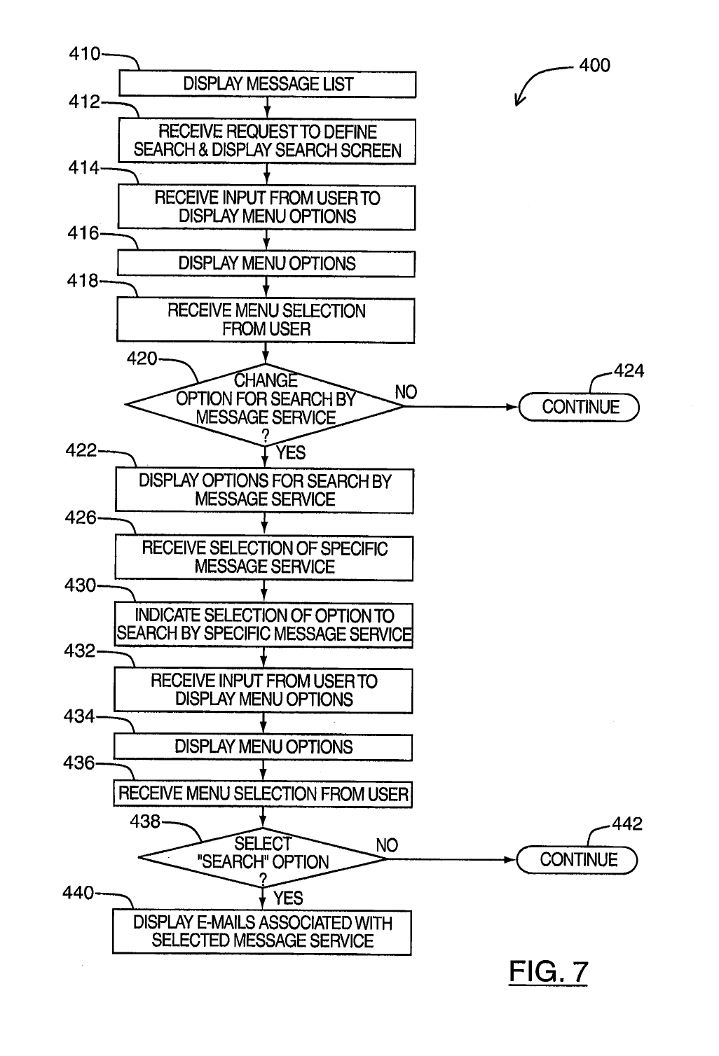

Referring now to FIG. 7, a flowchart illustrating steps of a method of searching for messages associated with a message service in at least one embodiment is shown generally as 400.

Some of the features described with reference to FIG. 7 have been described earlier in this description, and the reader is directed to the relevant paragraphs therein for additional details in respect of method 400. In one embodiment, the steps of method 400 are performed by an application, such as a messaging application, executing on a mobile device (e.g. device 22 of FIG. 1).

At step 410, a message list is displayed in a display screen (e.g. display 42 of FIG. 2) of the wireless communication device. Typically, in a message list view, the message list provides a summary of all messages (e.g. e-mail messages) in one or more message folders, subject to available space in the display.

For example, the message list may provide a summary of all e-mail messages in the “Inbox” folder on the wireless communication device. When the folder is not empty, the message list will comprise at least one list entry. Each list entry provides details of a message in the “Inbox” folder. At least some of the details will typically be extracted from the message header of the respective message. The types of information shown in a list entry may be user-configurable.

Given the relatively small size of display screens typically associated with mobile devices, the message list may be displayed in a message list view that occupies the entire display screen. However, the message list may alternatively be displayed in an area that partially occupies the display screen.

The user will typically be provided with a selection means, such as a highlight bar, a pointer, a cursor, or other means, to identify and select list entries in the message list. This selection means may be re-positioned at the direction of the user, using an input device such as a track wheel, track ball, keyboard, mouse, or other input device.

At step 412, a request from the user to define a search is received. In one embodiment, the user selects a “search” option from a menu that may be accessed by clicking a track wheel when viewing details in the message list in order to submit the request. A search screen is displayed in response to the request. The user may, for example, manipulate a track wheel to reposition a highlight bar or other selection means, such that a data input field associated with a specific search option is highlighted in the search screen.

At step 414, a request from the user to display menu options from within the search screen is received. In one embodiment, these menu options may be accessed by clicking a track wheel when viewing details in the search screen displayed at step 412. The menu options are displayed to the user at step 416.

At step 418, a menu selection is received from the user. If the menu selection indicates that the user has selected a “change option” item from the menu and the field associated with a message service has been highlighted or otherwise selected by the user as determined at step 420, this means that the user wishes to change the options for a search by message service, and the flow of method steps proceeds to step 422 where options for searching by message service are displayed. Otherwise, the flow of method steps proceeds to step 424 where the menu selection is further processed in known manner.

At step 422, different message services (e.g. accounts) are identified and displayed to the user in a menu. A selection of a message service (e.g. account) from the options displayed to the user is then received. An “all services” entry may also be provided and subsequently selected by the user. In one embodiment, a selection is made by manipulating the track wheel to reposition a highlight bar or other selection means, such that a specific message service is highlighted, and subsequently clicking the track wheel. This selection is received at step 426, and at step 430, the search screen is modified to indicate the specific service that was selected in respect of the option to search for e-mail messages associated with a message service.

At step 432, a request from the user to display menu options from within the search screen is received. In one embodiment, these menu options may be accessed by clicking a track wheel when viewing details in the search screen. The menu options are displayed to the user at step 434.

At step 436, a menu selection is received from the user. If the menu selection indicates that the user has selected a “search” item from the menu, this means that the user wishes to initiate the search with the currently-set parameters. For example, the user may have defined values for the search parameters such that all e-mail messages associated with the specific message service as selected by the user (or all messages regardless of service if an “all services” entry or the like has been selected) are to be returned by the search. In this case, the flow of method steps proceeds to step 440 at which search result entries identifying e-mail messages associated with the specified message service (or all messages regardless of service if an “all services” entry or the like has been selected) are displayed in a search result screen to the user. Otherwise, the flow of method steps proceeds to step 442 where the menu selection received at step 436 is further processed in known manner.

Although embodiments have been described herein that relate to the searching of e-mail messages by message service, one or more features described herein may be implemented such that other types of messages may be searched by message service, in variant embodiments.

The steps of a method of searching for messages by message service in embodiments described herein may be provided as executable software instructions stored on computer-readable media, which may include transmission-type media.

The invention has been described with regard to a number of embodiments. However, it will be understood by persons skilled in the art that other variants and modifications may be made without departing from the scope of the invention as defined in the claims appended hereto.

1. A method of searching for messages associated with a message service on a mobile device, the method comprising the steps of:
displaying a plurality of search parameters in a search screen to a user, wherein one of said plurality of search parameters is associated with an option to search for messages associated with a specified message service on the mobile device;
receiving a request from the user to modify the value of the search parameter associated with the option to search for messages associated with a specified message service;
displaying one or more user-selectable message services in response to the request;
receiving input identifying a message service selected by the user from the displayed user-selectable message services;
executing a message search; and
displaying results of the message search in a search results screen, wherein messages associated with the message service selected by the user are identified by the message search.

2. The method of claim 1, wherein at the step of displaying one or more user-selectable message services, only message services that are provisioned on the mobile device are displayed.

3. The method of claim 1, wherein the one or more user-selectable message services comprises an item that represents all message services that are provisioned on the mobile device.

4. The method of claim 1, wherein the plurality of search parameters is displayed to the user in a menu.

5. The method of claim 1, wherein the plurality of user-selectable message services is displayed to the user in a menu.

6. A computer-readable medium on which a plurality of executable instructions is stored, the instructions for performing the steps of the method of controlling the display of images on a mobile device as claimed in claim 1.

7. A system for searching messages associated with a message service on a mobile device, wherein the system comprises:
a processor;
a memory; and
a display screen;
wherein a messaging applications is executable by the processor; and
wherein the messaging application is programmed such that, in operation, the steps of the method as claimed in claim 1 are performed at the mobile device.
